(19) United States
(12) Patent Application Publication
(10) Pub. No.: US 2007/0267355 A1
(43) Pub. Date: Nov. 22, 2007

(54) Waste and Tailings Dewatering Treatment System and Method

(75) Inventors: Colin John Francis Phillip Jones, York (GB); John Lamont-Black, Newcastle Upon Tyne (GB); Stephanie Glendinning, Houghton-le-Spring (GB); Andries Benjamin Fourie, Perth (AU)

Correspondence Address: IPLM GROUP, P.A., POST OFFICE BOX 18455, MINNEAPOLIS, MN, 55418, US

(73) Assignee: Electrokinetic Limited

(21) Appl. No.: 10/583,306

(22) PCT Filed: Dec. 20, 2004
(86) PCT No.: PCT/GB04/05442

§ 371 Date: Apr. 24, 2007

(30) Foreign Application Priority Data
Dec. 19, 2003 (GB) 0329546.6

(51) Int. Cl. B01D 61/56; B01D 17/06; C02F 1/469; C02F 1/48; B01D 35/06

(52) U.S. Cl. 210/748; 210/243; 210/767

(57) ABSTRACT

An apparatus and method are described for reducing the liquid content of a material comprising a particulate/liquid dispersion or suspension, in particular comprising a dispersion or suspension of inorganic particles being a byproduct of mining, manufacturing or other industrial processes. The apparatus comprising a receiving zone to contain the material, at least one pair of electrodes spaced apart within the receiving zone, means to apply potential difference thereacross and hence across the material in use to drive electrokinetic dewatering, and drainage means to enable removal of water, wherein at least one of the electrodes comprises a textile or other synthetic material at least in part associated with a conductor so as to constitute where so associated a conducting electrokinetic textile or other synthetic material. The method makes use of the apparatus, in situ or at a remote site either as a batch or continuous process.

The invention relates to a system and method for the treatment of industrial wastes comprising a dispersion or suspension of solid particles, more particularly inorganic particles being a byproduct of mining, manufacturing or other industrial processes, in a liquid. The invention relates to a system and method to reduce the liquid content thereof. In particular the invention relates to a system and method for the dewatering of mine tailings and the like.

Industrial wastes are the by-products of construction, mining or manufacturing, agricultural and horticultural and other industrial processes. They possess both physical and chemical properties, which can interact with the natural or artificial ecosystems that they occupy.

Tailings waste lagoons and dams represent some of the largest man-made structures in the world. The large quantities of water stored in the voids of these tailings impoundments can make them potentially unstable and a potential risk to underlying ground water. Many tailings disposal facilities contain material that undergoes extremely slow self-weight consolidation. Examples include the fine tailings produced in the Oil Sands industry, and the waste products from the phosphate mining industry.

Social, legal and financial pressures are being directed towards the problems arising from industrial wastes. For example, in the United Kingdom the Special Waste Regulations (1996) SI 1996/972 have been replaced by the Hazardous Wastes Regulations in 2003/4 and the Landfill (England and Wales) Regulations (2002) SI 2002/1559 are soon to be enacted. These changes are likely to result in an increase in the cost of disposal of industrial wastes.

One approach to the waste problem is waste minimization. This can be achieved by reclamation, recycling or by volume reduction. It is apparent that these types of materials can be reduced significantly in volume if the solid content can be increased by dewatering. Mechanical methods alone are not necessarily effective over practical timescales. A known method to achieve more rapid dewatering in principle is by the use of electrokinetic processes, which remove or reduce the water content of the waste resulting in a significant overall reduction in the quantity of material that needs to be disposed of.

Electrokinetic Dewatering

Electrokinetic dewatering of materials relates to the movement of electrically charged particles known as electrophoresis, and the movement of water through a matrix of solid particles under an electric field usually referred to as electroosmosis. Both phenomena occur under the application of a direct (DC) electrical current. Electrophoresis deals with slurries or suspensions having a very low solids content, and electroosmosis can be used to treat mixtures and materials that have undergone some thickening and where the solid particles are in contact with one another forming a discrete matrix or skeleton.

The strength of an electrical charge on a clay particle, or its degree of electronegativity, is often quantified in terms of its zeta potential. The zeta potential is usually defined as the electrical potential at the junction between the fixed and mobile parts of the electrical double layer. It is dependent on the pH of the surrounding liquid and is also influenced by the valence of the ions present in a waste. As the association between clay surfaces and high valence cations increases, the zeta potential decreases. In some cases electrokinetic dewatering commences at 1V DC; with calcium clays dewatering may start between 5.5-10V DC and in the case of aluminum wastes 25V DC may need to be applied to start the process. The two key phenomena for electrokinetic dewatering are electrophoresis and electroosmosis.

Electrophoresis

Many waste materials (tailings) include a significant proportion of particles that are finer than 20 μm size. It is these particles which make electrophoresis dewatering possible as they usually have an electrically charged surface, most commonly a negative charge. Surrounding the charged particle is a double layer of cations, the concentration of which decreases with distance from the surface of the particle. Application of an electrical current to such a material causes movement of the ions. The charged particles will move towards the anode if negatively charged and towards the cathode if positively charged. This factor alone may not be the only reason that electrophoresis may be successful in clarifying water containing a suspension of fine material (tailings); changes in pH can also exert a major influence on the settling characteristics of clay particles.

Electroosmosis

It is established that the application of an electrical field across a soil sample results in the attraction of cations to the cathode and anions to the anode. As these ions migrate they drag their water of hydration with them resulting in a force on interstitial water that causes free water to migrate to one of the electrodes. As most clay soils tend to be negatively charged and thus surrounded by an outer cloud of positively charged water molecules, water migrates towards the cathode during electroosmotic dewatering. The rate of this water movement is independent of the pore size of the substrate and depends upon the applied voltage gradient and certain characteristics of the parent material. The independence of electroosmosis dewatering with respect to pore size means that the technique is much more effective than alternative methods in fine-grained substrates such as London Clay and like soils, mine tailings, drilling muds, farm wastes and the like.

The field applications of electroosmosis frequently relate to accelerated consolidation and strength gain in natural clay soils. As many industrial wastes are derived from clay minerals it is postulated that the technology can be applied to their treatment, particularly where dewatering is the basis of the improvement.

Difficulties of Electrokinetic Dewatering of Wastes

The application of electrokinetics to the treatment of wastes has been limited in particular by problems associated with the nature and form of available electrodes. Metal electrodes corrode causing degradation of the electro kinetic process, changes to the chemistry and potential contamination. Non-metallic systems have not been practical on an industrial scale. Accordingly, although the theoretical basis for application of electrokinetics to the treatment of wastes to reduce volume by dewatering is established, the practical application of systems and methods based on this has been limited to specialist situations and has not been successfully applied generally on an industrial scale

It is an object of the present invention to mitigate some or all of the above limitations.

It is a particular object of the present invention to provide an apparatus and method for the removal of liquid from industrial wastes comprising a dispersion or suspension of particles in a liquid, more particularly inorganic particles being a byproduct of mining, manufacturing or other industrial processes, which applies electrokinetic principles but is more practically applied to a range of wastes on an industrial scale than has been possible to date.

It is a particular object of the present invention to provide an apparatus and method for the removal of liquid from such industrial wastes offering enhanced speed and/ or efficiency and/or extent of liquid removal.

Thus according to the invention in a first aspect there is provided an apparatus for reducing the liquid content of a material comprising a particulate/liquid dispersion or suspension, and in particular comprising a dispersion or suspension of inorganic particles being a byproduct of mining, manufacturing or other industrial processes, the apparatus comprising a receiving zone to contain the material, at least one pair of electrodes spaced apart within the receiving zone, means to apply a potential difference thereacross and hence across the material in use to drive electrokinetic dewatering, and drainage means to enable removal of water, wherein at least one of the electrodes comprises a textile or other synthetic material at least in part associated with a conductor so as to constitute where so associated a conducting electrokinetic textile or other synthetic material.

The first electrokinetic textile or other synthetic electrode acts with the second remotely spaced electrode in contact with the material to allow application of a potential difference across the material to be treated in the receiving zone.

This enables an electrokinetic dewatering process to be driven. A drain draws off water at the cathode, and the material is dewatered, and so consolidated and reduced in volume.

The general chemistry is as above described. However, the novel use of the electrode material within the process overcomes many of the problems of prior art metal electrode systems. Materials in accordance with the invention can be made resistant to corrosion, and so do not adversely affect the electrochemistry of the system in use. They can readily be formed in a range of shapes. Further, they can combine the established geosynthetic functions of filtration, drainage and reinforcement as well as being electrically conductive. Such materials are found to be surprisingly and usually effective, not merely as an alternative to metal electrode systems, but as an element, even though the mode of action differs from that in the conventional application of such materials in the consolidation of soil structures.

The apparatus or method of the invention may provide for a separate drain at the cathode. However, this last feature can be exploited in a preferred embodiment in that the drain is provided in close association with, and in particular formed as an integral structure with, the conducting electrokinetic textile or other synthetic material electrode. In a particular example of this, the receiving zone is at least partly defined by a filtration membrane permeable to the liquid but impermeable to at least some and more preferably substantially all of the particulate solids contained within the material, which filtration membrane comprises a textile or other synthetic material at least in part associated with a conductor so as to constitute where so associated the said conducting electrokinetic textile or other synthetic electrode.

The electrokinetic textile thus combines a role as an electrode driving the electrokinetic enhancement of the dewatering process with a means of acting as a drainage/filter medium in a conventional filtration membrane role. It will be apparent that many of these advantages will also be relevant to the second electrode. According in a preferred embodiment, the second electrode is also a conducting electrokinetic textile or other synthetic material.

The filter membrane used in the apparatus or method is described as a textile or synthetic, which in this context means a sheet-like material having a primarily polymeric base structure. The textile may be woven, knitted, needle-punched, non-woven or otherwise fabricated. The textile may include conducting elements, which may be metallic, in a composite material composition, but is critically not fabricated entirely or primarily from metal alone. Particularly suitable materials will include those materials known for use as conducting geosynthetic materials.

A key to the apparatus or method of the invention especially in its preferred embodiment is that the textile or like synthetic material is able in use to function, at least over a part of the area thereof, as an electrokinetic textile/synthetic material. It will be apparent that this can be achieved in two ways.

First, it can be effected by provision of a separate conductor so disposed within the apparatus as to be caused during use to come into contact with the filtration membrane material over at least a part of the area thereof. In the alternative, it will in many instances be more convenient if the electrode is at least partly comprised of a conductor, either in that the material is inherently conducting or in that it integrally incorporates conductive material into its structure.

In the preferred embodiment the electrode also serves as a filtration membrane. In such a case the entire filtration membrane may integrally comprise conducting electrokinetic textile/synthetic material. Conveniently however, the filtration membrane preferably comprises a plurality of discrete conductive regions. This allows applied current in use to be limited to discrete areas within a receiving zone as required.

The electrodes provided for use in accordance with the apparatus or method invention do not corrode as readily as conventional electrodes. Previous attempts at introducing electrokinetic processes to industrial dewatering technology have frequently failed due to the rapid deterioration of the electrodes through corrosion and due to the electrochemical effect of this corrosion on the process. By contrast, there is a body of established technology, particularly in relation to electrokinetic geosynthetic materials, which will provide materials able to resist environmental degradation. In accordance with the invention, these materials are found to be surprisingly effective when applied to the dewatering of some industrial wastes. In the preferred case therefore, an electrokinetic geosynthetic material is used. This can provide all the functions of a conventional geosynthetic material (in particular an integral drainage and filtration function) as well as acting as an electrode. The results are positive although, whilst the invention is not limited by any theory of operation, it would appear as described with reference to the detailed examples below that the mode of action is surprisingly different to the mechanisms associated with their prior art uses in the consolidation of natural soils.

The principles of conducting electrokinetic geosynthetic materials have been established, and were for example set out in International Patent application number WO95/21965 to Jones et al incorporated herein by reference.

The EKG material of the electrode may have any suitable composition to give conductive properties. For example, the conductive geosynthetic material may comprise a generally inherently non-conductive geosynthetic material in association with at least one metallic or non-metallic conducting element to produce a composite conducting geosynthetic material. Alternatively, the geosynthetic material may be inherently conducting, for example being loaded with conducting particles, and for example comprising polymeric material loaded with carbon. Such inherently conducting geosynthetic material may additionally be associated with at least one separate metallic or non-metallic conducting element, to provide a composite conducting geosynthetic.

In a preferred embodiment, the electrokinetic material (EKG) comprises a woven or non-woven polymeric and for example geosynthetic material incorporating a plurality of elongate conducting elements therewithin, in particular in one or more parallel arrays. Two or more arrays may be disposed in different directions to form a network structure. The elongate conducting elements conveniently comprise thread, tape, wire or the like. Preferably, the conducting elements are integrally within the structure. The conducting elements may for example be threaded through or woven or knitted into the basic textile/geosynthetic material. Where the EKG comprises also a filtration membrane this will generally comprise sheet material, and the elongate conducting elements will be disposed generally laterally therewithin. For example the sheet is a woven structure, and the elongate conducting elements comprise warp and/or weft elements of the woven sheet structure.

A possible electrically conducting geosynthetic material could simply comprise a conventional geosynthetic material which has woven therein, or threaded therethrough, electrically conducting filaments or threads which may be single or multi-stranded. The filaments or threads comprise conducting elements. In the instance where the electrically conducting geosynthetic is woven, electrically conducting threads or filaments may be intertwined with or enmeshed within conventional geosynthetic materials and in the instance where the electrically conducting geosynthetic is provided in a threaded form any preselected number of passages of thread through the material may be made according to a user's requirement.

The conducting elements may be metallic material. The environment generated by many of materials to be dewatered can be particularly harshly corrosive, and in order to get a satisfactory electrode life, the metallic conducting elements must be carefully selected for the environment. During electroosmotic dewatering, the environment at an electrode functioning as an anode is likely to be particularly harsh, and might require an especially chemically resistant material.

In a particular embodiment, for dewatering of materials that can be particularly harshly corrosive, an electrode comprises conducting elements fabricated from metal coated in mixed metal oxide, for example in sheet, tape, wire or thread form. The technology of coating with mixed metal oxides is established, and the skilled person will readily understand the materials encompassed by this term. In particular, the coating should comprise materials selected from the oxides of tantalum, niobium, iridium, palladium, ruthenium, rhodium and mixtures thereof. The metal core may be formed of any suitable metal having regard to the intended application. For example in harshly corrosive environments, and/or to allow for imperfections and/or damage to the coating the metallic material forming the core is preferably a material capable of forming an effective passivating oxide layer, such as for example titanium, niobium, zirconium and alloys thereof. If environmental and/or service life considerations allow, a core formed of a metal exhibiting a lesser but still reasonable degree of stability in the corrosive environment such as stainless steel or copper might be acceptable.

In a less harsh environment, conducting elements fabricated from less resistant elements such as stainless steel elements might be used.

Electrodes provided in accordance with the invention do not corrode readily. Previous attempts at introducing electrokinetic processes to dewatering of these materials have frequently been discounted due to the rapid deterioration of the electrodes. By contrast, there is a body of established EKG and like technology which will provide materials able to resist environmental degradation. The refinement of technological principles from this area to provide electrodes, for example in the form of textile sheets, incorporating conductive elements comprising metal coated with MMO is particularly corrosion resistant.

The ability of electrokinetic phenomena to move water, charged particles and free ions through fine-grained low permeability substrate is established. There are five principal electrokinetic phenomena: streaming potential, migration potential, electroosmosis, ion migration and electrophoresis. The last three are concerned with the transport mechanisms developed upon application of an electrical field across a substrate mass and are relevant to the present invention, which exploits electroosmosis in particular.

To generate an electroosmotic effect, an electrical field is applied across a mass of material in the receiving zone. Cations are attracted to the cathode and anions to the anode. The transport mechanism is as explained above. In order to maintain a charge neutrality, there are more cations than anions in the pore fluid of the substrate containing negatively charged particles. Therefore there is usually a net flow of water to the cathode. This electroosmotic flow depends upon the applied voltage gradient and the electroosmotic permeability of the material.

In accordance with the invention, the electrokinetically induced drainage enhances the liquid removal process. For a given material, advantages can be obtained both relating to the speed at which liquid is removed and relating to the maximum degree of drying which can be practically obtained.

The receiving zone may comprise a real, closed containment means into which waste material may be fed for batch processing, or may comprise a treatment zone in an unclosed, semi-contained, continuous processing system. For example it may comprise containment means defining a conduit with an untreated material input, a treated material output remote therefrom, and a treatment zone therewithin. In either case, the containment means preferably comprises at least in part a filtration membrane being associated with a conductor for at least a part of the extent thereof to serve as a combined electrode and filter/drain in the manner above described.

Where it is desired to apply a potential difference across the material in a region relating to only a part of such a filtration membrane, this may be achieved in that a conductor is associated only with that part of the filtration membrane. Alternatively, conductors may be associated with the membrane across substantially its entire area, for example in a plurality of discrete regions, but only electrically supplied in the desired region. Where the membrane comprises EKG material, the latter approach may be preferred.

It will be understood that none of the foregoing requires the area associated with the conductor or the second electrode to be continuous in the region where a potential difference is to be applied. Either or both may instead be disposed as a discontinuous plural array provided that the arrangement permits the application of the necessary potential difference across the material to be dewatered to generate the necessary electrokinetic effect.

In accordance with the invention in a further aspect there is provided a method of reducing the liquid content of a material comprising a particulate/liquid dispersion or suspension, and in particular comprising a dispersion or suspension of inorganic particles being a byproduct of mining, manufacturing or other industrial processes, the method comprising receiving untreated material in a receiving zone; providing at least one pair of electrodes spaced apart within the receiving zone, at least one of which comprises a textile or other synthetic material at least in part associated with a conductor so as to constitute where so associated a conducting electrokinetic textile or other synthetic material electrode; applying a potential difference thereacross and hence across the material to drive electrokinetic dewatering; removing water thus driven to the cathode by suitable drainage means.

The method may be to dewater the material in situ by locating the electrodes in, and creating a receiving zone in situ within, a material site such as a tailings dam or lagoon or the like. The material may be treated remotely. The method may then be a batch process, in which case the untreated material is then simply taken to and received within a receiving zone in a suitable apparatus, treated, and removed from the receiving zone. Alternatively, the method may be a continuous process, wherein the receiving zone comprises a treatment zone in a conduit between an input and an output thereof, and the method comprises feeding untreated material into the input, causing the material to travel therealong through the treatment zone where the above dewatering method is applied, and removing the treated material at the output.

In particular the method is a method for the treatment of inorganic mining or industrial waste and especially mine tailings by dewatering.

The invention will now be described by way of example only with reference to FIGS. 1 to 4, representing experimental date for dewatering employing the principles of the invention, and FIG. 5 which is a schematic of a suitable filtration material.

### EXAMPLE 1

### Accelerated Thickening of Suspended Diamond Tailings (Electrophoresis)

The material treated was obtained from a diamond mine tailings impoundment. A feature of the waste was that it contained extremely fine clay particles which do not settle out, resulting in the decant water having such a high suspended solids content (1 to 2%) that it cannot be reused in the metallurgical plant, nor can it be released into a water course. Previous efforts to clarify the water by adding lime and organic flocculants were unsuccessful and all the water has to be retained in an impoundment. This is an uneconomic use of space, which could better be used to store tailings solids.

The dominant mineral in the tailings waste, determined by X-ray diffraction was montmorillonite, the Plasticity Index (PI) was 38 and the percentage of material finer than 2 μm was 41%. The pH of the tailings water ranged between 8.9 and 9.0. The ambient pH of around 9 corresponds to the region of most negative zeta potential. The suspension remained stable at this pH as the repulsive forces are at their maximum. Altering the pH, by the addition of an acidic solution could eventually reduce the repulsive forces sufficiently to enable agglomeration of suspended particles to occur. The costs of this approach are high and electrophoresis offers an alternative solution.

In the tests, two EKG electrodes in the form of an electrical Prefabricated Drain (e-PVD) were suspended vertically in a container containing a sample of the tailings. A separate control container was located next to the experimental container to provide quantification of evaporation losses. A voltage of 10V with a 1.15 A current was applied at the start of the test. During the experiment the pH at the anode, cathode and centre of the test cell was measured together with the current drawn. The volume of water lost to evaporation was determined. The tests were repeated at potentials of 20V and 30V.

FIG. 1 illustrates the change of pH with time for diamond tailings suspensions tested at different voltages and shows that the pH rose steadily as each test progressed, with a more rapid rise being apparent for voltages of 20V and 30V. The ubiquitous rise in pH is different to what usually occurs near to a metallic anode, where a drop in pH is usually observed; this is due to an alternate anode reaction that occurs with an EKG electrode, namely electrolysis.

The turbidity of the solution did not change until a pH value of approximately 10.5 was reached, after which the solution cleared rapidly, with the solid particles settling out within a matter of hours. Settlement of the fine particles corresponded to the point at which the zeta potential became less negative.

This was confirmed in settling tests undertaken in measuring cylinders in which the pH solution was adjusted by the addition of either sodium hydroxide or hydrochloric acid to raise or lower the pH respectively.

### EXAMPLE 2

### Accelerated Consolidation of Tailings Slurries (Electroosmosis)

The potential for electroosmotic consolidation of mine tailings has been investigated using an electroosmotic cell. The materials tested were a mineral sands tailings and diamond tailings

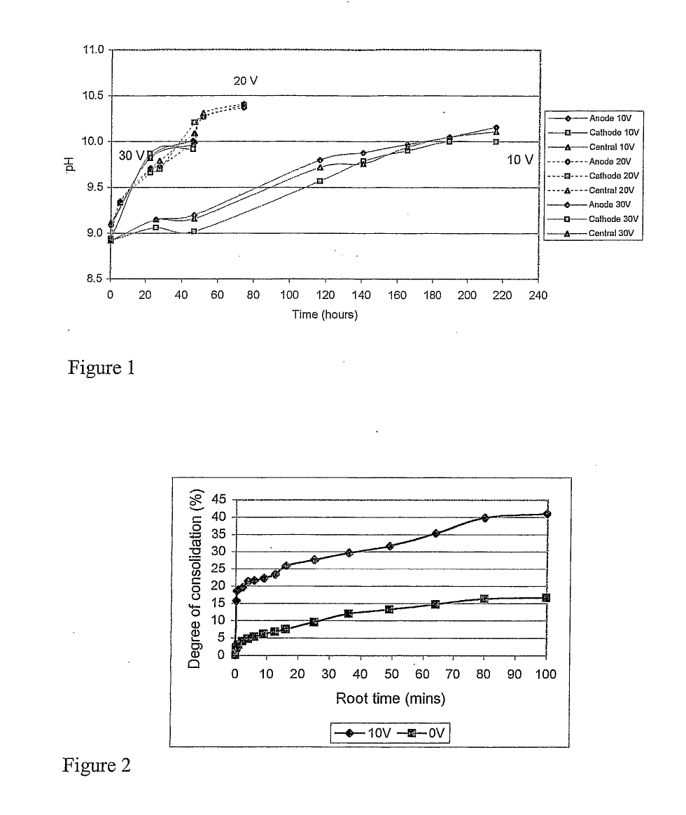

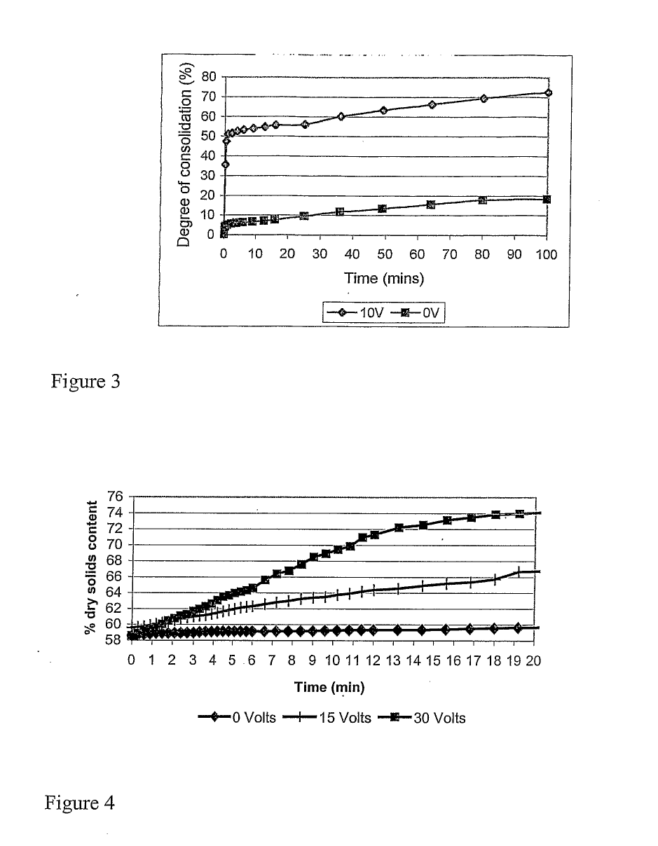

The results of the tests are shown in FIGS. 2 and 3. FIG. 2 shows the variation in degree of consolidation with time for mineral sands tailings, and FIG. 3 shows the variation in degree of consolidation with time for diamond tailings.

The results are provided in terms of the degree of consolidation versus time for the two tailings under an applied vertical total stress of 25 kPa. The results relate to the first one hundred minutes of testing, as this emphasizes the significance of the electroosmotic effect. The amount of final settlement of the tailings specimens was similar (about 5% more in the electroosmosis test), but the rates of consolidation of the electrically treated material were significantly different to the control materials, particularly in the early stages of a test. It is difficult, if not meaningless, to calculate conventional coefficients of consolidation (cᵥ) values for the electroosmotic tests because the time-settlement curves differ so markedly from classical soil mechanic consolidation curves. In particular, it was unexpectedly found that for the diamond mine tailings approximately 50% of the total consolidation settlement occurred within one minute of the start of the test. In the case of the mineral sands 19% of the consolidation occurred within one minute and 40% after 100 minutes. Following this very rapid period of electrically induced consolidation, the time vs. degree of consolidation curves become approximately linear until final settlement was reached.

The main benefit in using electroosmotic treatment using EKG electrodes is not so much the amount of final settlement achieved, but rather the speed with which the settlement is achieved, that is so impressive. Considering that up to 50% of the final settlement occurred in about a minute, it may be that the application of an electrokinetic force is only required for a short period and then natural self-weight consolidation may be used. In this second stage the primary function of the EKG would be to filter fine particles, allowing only clean process water to enter the EKG, which would preferably be formed as an e-PVD.

### EXAMPLE 3

### Application of EKG Materials to Tailings Dewatering

EKG materials can be formed as linear elements such as e-PVD wick drains or tapes, or in 2-dimensional forms such as belts or sheets. In continuous processes, the use of electrically conductive belts or sheets may be preferred for example in a hydraulic press arrangement so that dewatering proceeds via both hydraulic and electrokinetic mechanisms.

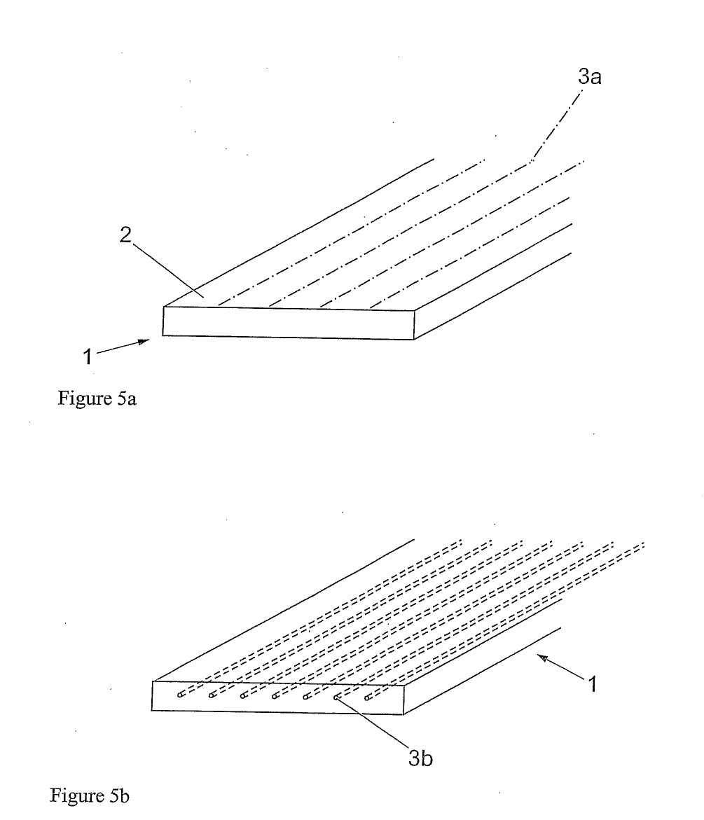

FIG. 4 shows test data for such a system, plotting data for dewatering of diamond mine tailings % dry solids vs time under tlhree voltage conditions. In each example a 15 mm thick sample is tested for 20 minutes residence time at 70 kPa pressure. Applied potential for the three datasets is 0 (control), 15V and 30V. This shows the difference in dewatering that was found between the hydraulic only pressure typical of belt presses (0V) and hydraulic plus two different voltages 15V and 30V.

FIG. 5 illustrates a sheet material suitable for use in accordance with the invention, for example as such a belt in a belt filter press or as a filtration sheet for a cell for a batch system. In each case a woven sheet or belt 1 is formed from a base of woven polymeric material 2, to that extent comprising for example a conventional geotextile or geotextile-like material providing a drainage and filtration function. Suitable materials will include polyester, polypropylene and polyamides.

A parallel array of elongate conductors is provided in association with the sheet or belt 1. The sheet or belt may be a woven or knitted textile formed from a base of polymeric material into which is incorporated, preferably woven or knitted into the structure, one or more arrays of elongate conductors 3. Suitable materials for the conductors will include carbon, coated metals, in particular metals coated in mixed metal oxides, and conductive polymers. In the example, electrode wires are wires of 0.8 mm and 0.65 mm diameter, and are titanium, stainless steel or copper coated with mixed metal oxide (MMO). The MMO should be an iridium-tantalum-based material of the type used for oxygen evolution in cathodic protection applications.

Two alternative arrangements of conductor element are shown. In FIG. 5a an array of elongate conductors 3a is disposed on an upper surface 2 of the sheet or belt 1 in intimate contact therewith and a second array of elongate conductors (not shown) is disposed on a lower surface. In FIG. 5b an array of elongate conductors 3b is disposed within the sheet or belt 1.

The drainage and filtration material is conveniently a belt for a belt press. The belt press is formed with conducting belt elements being provided with conductors in or on the surface of the belt in the manner, for example, of FIG. 5. The figure illustrates simple single layer parallel conductor geometries lying along a belt direction, but this is illustrative only and other geometries could readily suggest themselves. For example, conductors may lie in other directions, in multiple layers, in a two-dimension network by being angled relative to each other etc.

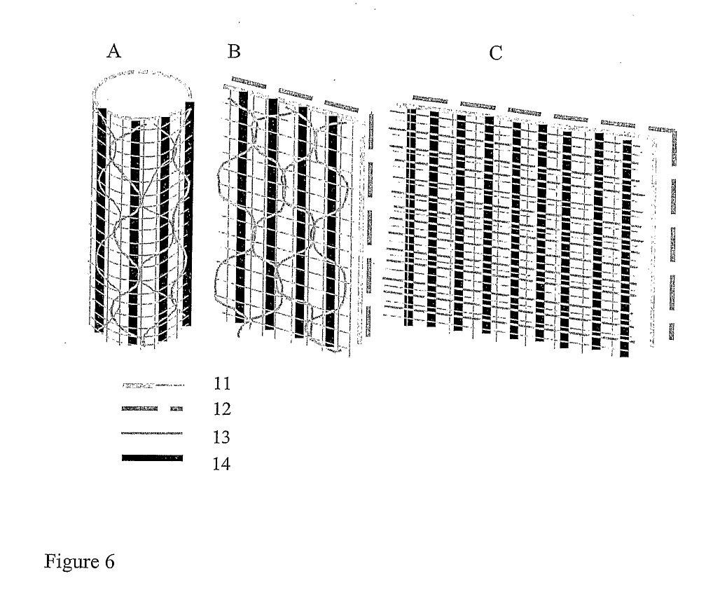

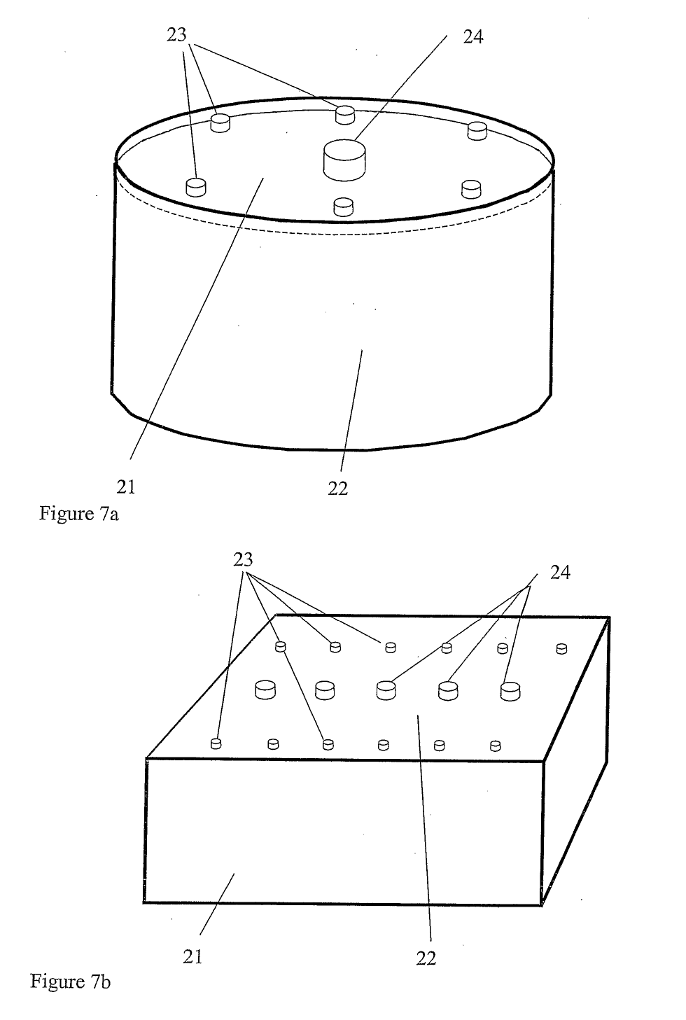

FIG. 6 shows some geometries in more detail. FIG. 6 example A is a sock structure, example B is a folded strip, and example C is a grid. In each case elements comprise a woven base fabric 11, a non-woven filter fabric 12, Primary axial carriers (PAC) 14, and secondary transverse distributors 13 which may include some sacrificial elements.

With batch processes, e-PVD wick drains are likely to provide an optimum configuration as, following the electrokinetic phase, the filtration and drainage properties of the material can be utilized. Two examples are given in FIG. 6. In each case waste 21 is retained within a suitable container, lagoon etc 22, and e-PVD anodes 23 and cathodes 24 are inserted into the waste as shown.

1. An apparatus for reducing the liquid content of a material comprising a particulate/liquid dispersion or suspension, the apparatus comprising a receiving zone to contain the material, at least one pair of electrodes spaced apart within the receiving zone, having a potential difference thereacross and hence across the material in use to drive electro-kinetic dewatering, and a drain to enable removal of water, wherein at least one of the electrodes comprises a textile or other synthetic material at least in part associated with a conductor so as to constitute where so associated a conducting electrokinetic textile or other synthetic material.

2. An apparatus in accordance with claim 1 for reducing the liquid content of a material comprising a dispersion or suspension of inorganic particles being a byproduct of mining, manufacturing or other industrial processes.

3. An apparatus in accordance with claim 1 wherein the second electrode is also a conducting electrokinetic textile or other synthetic material.

4. An apparatus in accordance with claim 1 wherein the drain is formed as an integral structure with the conducting electrokinetic textile or other synthetic material electrode.

5. An apparatus in accordance with claim 4 wherein the receiving zone is at least partly defined by a filtration membrane permeable to the liquid but impermeable to at least some and more preferably substantially all of the particulate solids contained within the material, which filtration membrane comprises a textile or other synthetic material at least in part associated with a conductor so as to constitute where so associated the said conducting electrokinetic textile or other synthetic electrode.

6. An apparatus in accordance with claim 5 wherein the filter membrane is a sheet-like material having a primarily polymeric base structure.

7. An apparatus in accordance with claim 6 wherein the filter membrane includes conducting elements in a composite material composition.

8. An apparatus in accordance with claim 5 wherein the apparatus further comprises a separate conductor so disposed within the apparatus as to be caused during use to come into contact with the filtration membrane material over at least a part of the area thereof.

9. An apparatus in accordance with claim 5 wherein the electrode is at least partly comprises a conductor, either in that the material is inherently conducting or in that it integrally incorporates conductive material into its structure.

10. An apparatus in accordance with claim 9 wherein the electrode comprises a conducting geosynthetic material.

11. An apparatus in accordance with claim 10 wherein the electrode comprises a generally inherently non-conductive geosynthetic material in association with at least one metallic or non-metallic conducting element to produce a composite conducting geosynthetic material.

12. An apparatus in accordance with claim 11 wherein the electrokinetic material comprises a woven or non-woven polymeric material incorporating a plurality of elongate conducting elements therewithin, in particular in one or more parallel arrays.

13. An apparatus in accordance with claim 11 wherein a conducting element comprises metal coated in mixed metal oxide.

14. An apparatus in accordance with claim 10 wherein the electrode comprises inherently conducting material.

15. A method of reducing the liquid content of a material comprising a particulate/liquid dispersion or suspension, the method comprising receiving untreated material in a receiving zone; providing at least one pair of electrodes spaced apart within the receiving zone, at least one of which comprises a textile or other synthetic material at least in part associated with a conductor so as to constitute where so associated a conducting electrokinetic textile or other synthetic material electrode; applying a potential difference thereacross and hence across the material to drive electro-kinetic dewatering; removing water thus driven to the cathode with a drain.

16. The method of claim 15 operated to dewater the material in situ, and comprising locating the electrodes in, and thereby creating a receiving zone in situ within, a material site such as a tailings dam or lagoon or the like, and treating the material in accordance with claim 15.

17. The method of claim 15 operated as a batch process, comprising transporting untreated material to and receiving untreated material within a receiving zone in a suitable apparatus, treating the material in accordance with claim 15, and removing the treated material from the receiving zone.

18. The method of claim 15 operated as a continuous process, wherein the receiving zone comprises a treatment zone in a conduit between an input and an output thereof, and the method comprises feeding untreated material into the input, causing the material to travel therealong through the treatment zone where the above dewatering treatment in accordance with claim 15 is applied, and removing the treated material at the output.

19. The method claim 15 wherein the method is applied to inorganic mining or industrial waste.

20. The method of claim 19 wherein the mining waste comprises mine tailings.

21. The method of claim 14 wherein the inherently conducting material is a polymeric material comprising conducting particles.
